(19) United States
(12) Patent Application Publication
(10) Pub. No.: US 2026/0307288 A1
(43) Pub. Date: Oct. 8, 2026

(54) FOOD PROCESSING SYSTEMS AND METHODS

(71) Applicant: Proex Food, LLC, Menomonee Falls, WI (US)

(72) Inventors: Daniel Ghadiri, Chicago, IL (US); Aaron Jerome Mett, West Bend, WI (US)

(73) Assignee: Proex Food, LLC, Menomonee Falls, WI (US)

(21) Appl. No.: 19/172,821

(22) Filed: Apr. 8, 2025

(51) Int. Cl. B26D 7/06; A01F 11/06; A23N 15/00; B26D 3/24

(52) U.S. Cl. CPC B26D 7/0625; A01F 11/06; A23N 15/00; B26D 3/24

(57) ABSTRACT

A food processing system for processing a food product includes a conveyor configured to convey the food product in a first direction, a sensing system configured to sense the food product on the conveyor and output corresponding signals, a control system that receives the signals from the sensing system and determine orientation of the food product on the conveyor, and a robot configured to engage the food product, move the food product in the first direction, reorientate the food product, and release the food product onto the conveyor when the control system determines that the food product is improperly orientated.

### FIELD

The present disclosure relates to food processing systems and methods.

### BACKGROUND

Food products, such as produce, are harvested and taken to facilities in which the food products are processed for consumption. Some facilities process the food products for further processing at other facilities and other facilities process the food products for sale in grocery stores and convenience stores. Facilities can process large quantities of food products. In certain examples, produce processing facilities focus on cleaning, processing, and/or packaging produce for sale in grocery or convenience stores.

The following U.S. Patent Application Publication is incorporated herein by reference in entirety.

U.S. Patent Application Publication No. 2024/0208098 discloses a food processing system for processing a food product that includes an imaging system for generating an image of the food product and a control system. The control system is configured to process the image of the food product and determine a product region of the image related to the food product. A robot is configured to move the food product into a processing section. The processing section is configured to cut the food product and dispense a processed food product that corresponds to the desired product region.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a method for processing a food product includes conveying, with a conveyor, the food product in a first direction, sensing, with a sensing system, the food product, determining, with a control system, orientation of the food product, engaging, with a robot, the food product, reorienting, with the robot, the food product, and placing, with the robot, the food product onto the conveyor.

In certain examples, a food processing system for processing a food product includes a conveyor configured to convey the food product in a first direction, a sensing system configured to sense the food product on the conveyor and output corresponding signals, a control system that receives the signals from the sensing system and determine orientation of the food product on the conveyor, and a robot configured to engage the food product, move the food product in the first direction, reorientate the food product, and release the food product onto the conveyor when the control system determines that the food product is improperly orientated.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIGS. 1-2 are schematic views of an example food processing system according to the present disclosure.

FIG. 3 is a schematic view of an example input section according to the present disclosure.

FIGS. 4-5 are schematic views of an example alignment section according to the present disclosure.

FIG. 6 is a schematic view of an example control system according to the present disclosure.

FIGS. 7-11 are schematic views of an example operational sequence for an example food processing system according to the present disclosure.

FIG. 12 is an example method according to the present disclosure.

### DETAILED DESCRIPTION

The present inventors have recognized that there is a need in the food product processing industry to process food products, such as produce, quickly to thereby increase production. As such, the present inventors have endeavored to develop the example systems and methods of the present disclosure described herein below that increase the efficiency and/or effectiveness of processing facilities that process food products. The systems can also decrease the amount of labor needed for quality control in processing facilities, while also improving accuracy and efficiency of quality control.

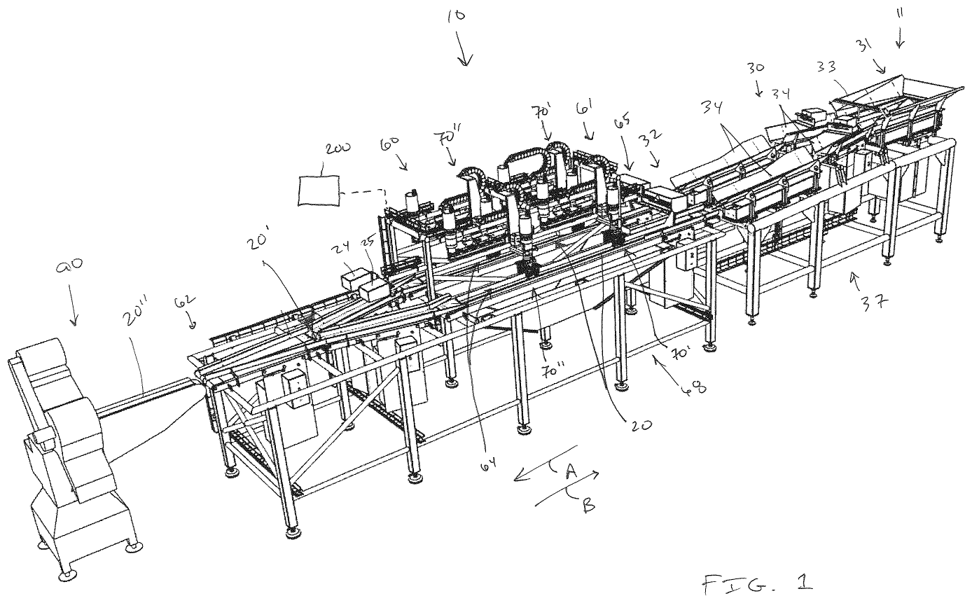

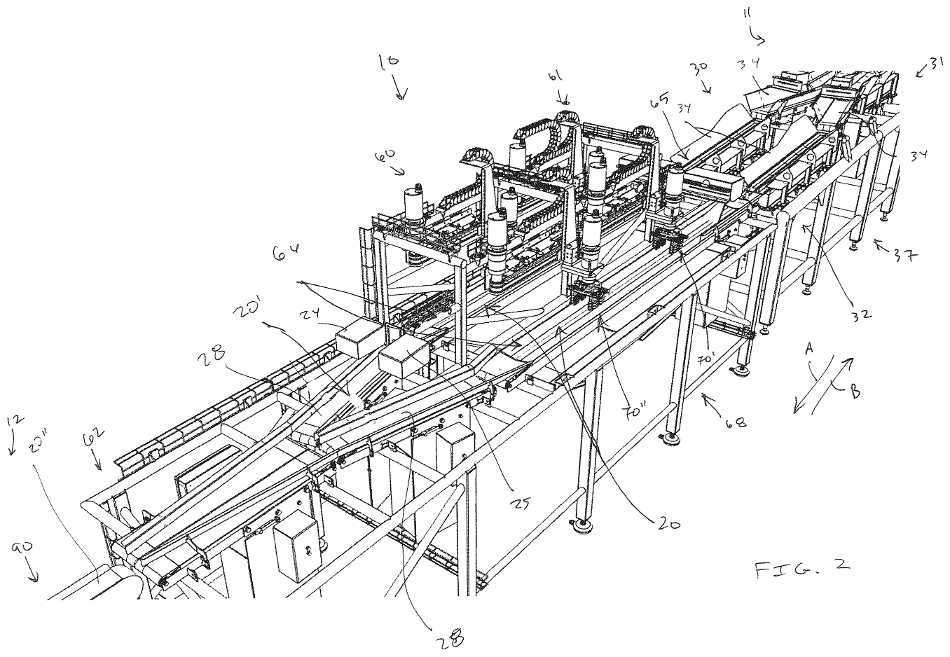

FIGS. 1-2 depicts an example food packing or processing system 10 of the present disclosure. The food processing system 10 includes an upstream first end 11 and a downstream second end 12. The food processing system 10 includes one or more sections (some example sections are described further herein below) positioned between the ends 11, 12. The food processing system 10 includes one or more conveyors 20 extending between the end 11, 12 that are configured to convey food products, such as produce like corn, from the first end 11 to the second end 12 in a downstream first direction (arrow A). The type of conveyor 20 can vary, and in one example, the conveyors 20 are endless belts. The conveyors 20 can include converging conveyor sections 20′ (described further herein). In other examples, the converging conveyor sections 20′ may be conveyors 20 that are independent from adjacent conveyors 20.

The type of food products conveyed by the conveyors 20 can vary. In one example, the food products are produce such as corn. In other examples, the conveyors 20 convey other produce such as romaine lettuce, cucumbers, and/or meat. Note that example food processing systems 10 described herein refer to ears of corn as ‘corn’. Further note that the example food processing systems 10 described herein are not limited to processing corn such that the example food processing systems 10 and the features or components of the example food processing systems 10 can be utilized with and process any other food products.

The food processing system 10 generally includes an input section 30 that receives corn C from an upstream infeed equipment or machines (not depicted; e.g., hopper) and dispenses the corn C alignment section 60. The alignment section 60 is configured to sense the corn C and align the in a proper orientation. The corn exiting the alignment section 60 are dispensed to a cutter section 90 that is configured to cut the kernels from the cob. An example cutter section 90 includes a cutting device that is configured to cut the kernels from the cob. An example cutter is publicly available for purchase from A&K Processing Machinery (model #3). The sections 30, 60, and 90 are described in greater detail hereinbelow.

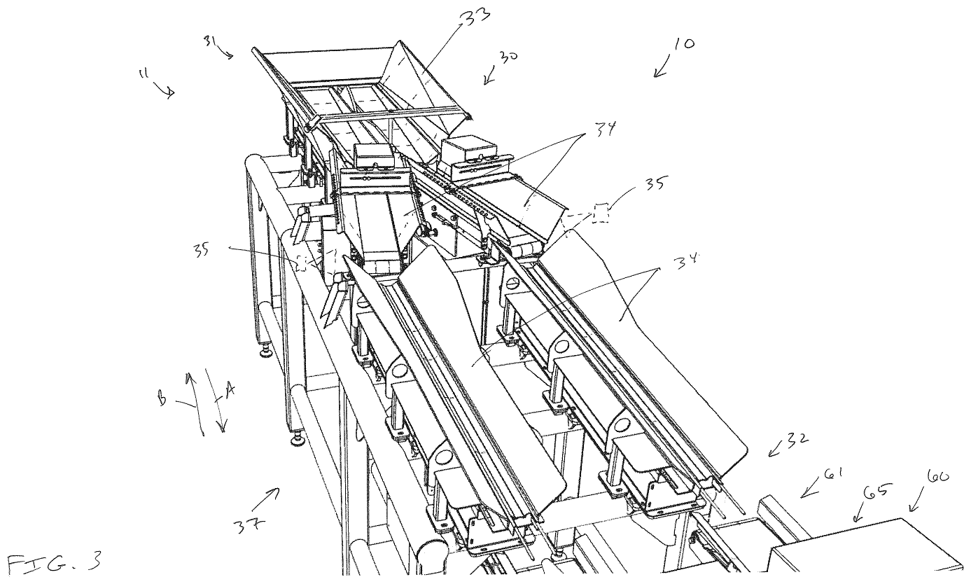

FIG. 3 depicts the input section 30 in more detail. The input section 30 includes an upstream first end 31 that receives the corn and an opposite downstream second end 32 that dispenses the corn to the alignment section 60 (FIG. 3). The input section 30 includes on or more shaker tables 33 that are configured to move the corn C in the first direction (arrow A) and cause the corn to move in one or more rows such that the corn C are orientated lengthwise with a longitudinal corn axis of the corn C (e.g., the corn axis extends between the tip end and the tail end of the corn C). The shaker tables 33 dispense the corn C onto downstream input section conveyors 34.

The number of shaker tables 33 and the number of input section conveyors 34 can vary, and in the example depicted in FIGS. 2-4, one shaker table 33 is depicted with four input section conveyors 34. A frame 37 vertically supports the shaker tables 33. One or more actuator (not depicted; e.g., motor with a vibrating element) shakes or vibrates the shaker tables 33. As such, the corn C is shaken and into rows of single corn C oriented lengthwise. Note that in certain examples, the speed of the conveyors 20 and/or the input section conveyors 34 are controlled by a control system 200 (described further herein) to ensure that the corn C are organized in rows corn C one after another without corn C being overlapped or positioned laterally next to each other.

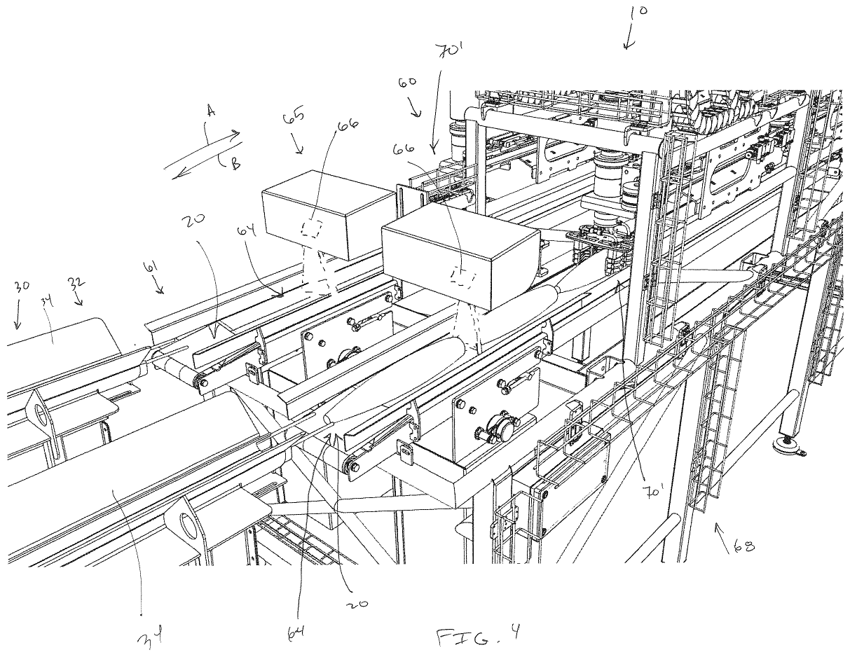

The one or more rows are corn C are received into the alignment section 60, which is depicted in greater detail in FIGS. 4-8. The alignment section 60 includes an upstream first alignment end 61 and a downstream second alignment end 62. The corn C are conveyed along two paths 64 (note that several schematic representations of the corn C in one of the paths 64 is depicted in FIG. 4). One or more conveyors 20 convey the corn C along the paths 64 from the first alignment end 61 to the second alignment end 62. Note that the number of paths 64 can vary. For example, another example alignment section 60 includes five paths 64 along which the corn C are conveyed.

The alignment section 60 includes a sensing system 65 for sensing the corn C in the paths 64. Note that in other examples, the sensing system 65 is independent from the alignment section 60 or part of the input section 30.

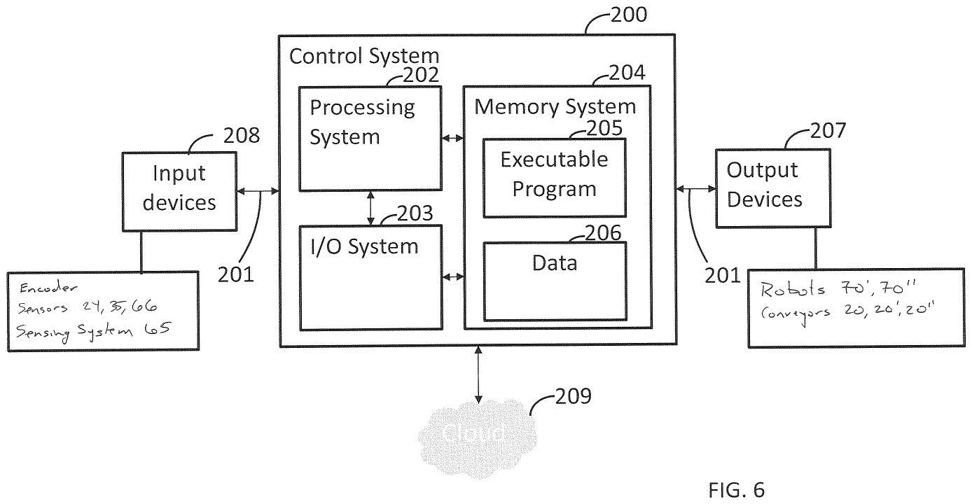

The sensor 66 and/or the sensing system 65 are in communication with a control system 200 (described further herein; see FIG. 6). Generally, the sensor 66 and/or the sensing system 65 output data and/or signals to the control system 200 that correspond to the corn C being sensed and the control system 200 controls various features and/or components of the food processing system 10.

Certain aspects of the present disclosure are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processors or other control devices. The connections between functional and logical block components are merely exemplary, which may be direct or indirect, and may follow alternate pathways.

In certain examples, the control system 200 communicates with each of the one or more components of the food processing system 10 via a communication link 201, which can be any wired or wireless link. The control system 200 is capable of receiving information and/or controlling one or more operational characteristics of the food processing system 10 and its various sub-systems by sending and receiving control signals via the communication links 201. In one example, the communication link 201 is a controller area network (CAN) bus; however, other types of links could be used. It will be recognized that the extent of connections and the communication links 201 may in fact be one or more shared connections, or links, among some or all of the components in the food processing system 10. Moreover, the communication link 201 lines are meant only to demonstrate that the various control elements are capable of communicating with one another, and do not represent actual wiring connections between the various elements, nor do they represent the only paths of communication between the elements. Additionally, the food processing system 10 may incorporate various types of communication devices and systems, and thus the illustrated communication links 201 may in fact represent various different types of wireless and/or wired data communication systems. The control system 200 can optionally includes a timer.

The control system 200 may be a computing system that includes a processing system 202, memory system 204, and input/output (I/O) system 203 for communicating with other devices, such as input devices 208 (e.g., sensor 66, encoders) and output devices 207 (e.g., robots 70′, 70″), either of which may also or alternatively be stored in a cloud 209. The processing system 202 loads and executes an executable program 205 from the memory system 204, accesses data 206 stored within the memory system 204, and directs the food processing system 10 to operate as described in further detail below.

The processing system 202 may be implemented as a single microprocessor or other circuitry, or be distributed across multiple processing devices or sub-systems that cooperate to execute the executable program 205 from the memory system 204. Non-limiting examples of the processing system include general purpose central processing units, application specific processors, and logic devices.

The memory system 204 may comprise any storage media readable by the processing system 202 and capable of storing the executable program 205 and/or data 206. The memory system 204 may be implemented as a single storage device, or be distributed across multiple storage devices or sub-systems that cooperate to store computer readable instructions, data structures, program modules, or other data. The memory system 204 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

The sensing system 65 includes one or more sensors 66 for sensing the corn C being conveyed along the paths 64. The sensor 66 senses the corn C as the conveyor 20 continuously or intermittently conveys the corn C in the first direction (arrow A) past the sensor 66. Note that while the example sensing system 65 described herein describes one sensor 66 for sensing the corn C in one of the paths 64, other example sensing systems 65 can include one or more sensors 66 for sensing the corn C being conveyed by the conveyor(s) 20 in one or more paths 64. In one example, the sensing system 65 includes a first sensor 66 for sensing the corn C in a first path 64 and a second sensor 66 for sensing the corn C in a second path 64. In another example, the sensor 66 senses the corn C in multiple paths 64.

The sensor 66 can be any suitable system or device for sensing the corn C such as an imaging device such as an x-ray generator and receptor system, a photo eye, a camera capable of imaging visible light wavelengths, a laser curtain system, a 2D or 3D imaging system, and/or the like. In certain examples, the sensor 66 is configured to generate an image (e.g., two-dimensional image (2D) or three-dimensional image (3D)) of the corn C, signals, and/or data corresponding to the corn C.

The sensing system 65 can include and store information regarding the operation of the sensor 66, and the sensing system 65 can include a processor that retrieves instructions and data from the control system 200 (e.g., the memory system 204 of the control system 200) for executing instructions and operational sequences, processing the data to generate images, outputting the images to a display or to the control system 200, and/or outputting other data and/or signals. In certain examples, the sensing system 65 transmits the signals and/or data to the control system 200, external systems, networks, and/or devices and the sensing system 65 also receives signals and/or data from the control system 200, external systems, networks, and/or devices.

The control system 200 can be configured to receive signals and/or data from the sensing system 65 to determine and identify various features of the corn C such as edges, thicknesses, and/or defects of the corn C. The control system 200 may use any known processing modules such as edged detection modules, image reduction modules, de-noising modules, and the like for determining edges, thicknesses, outer limits of the good quality portions of the corn C, defects, color, gaping and/or the like. Reference is made to U.S. Patent Application Publication No. 2012/0307013, which is incorporated by reference in its entirety, for example mapping procedures, cutting tools, processing steps (e.g., determining the center of gravity), components, and/or features that can be combined with the example food processing systems 10 of the present disclosure.

The control system 200 is configured to determine and/or track the movement of each corn C on the conveyor(s) 20 as the conveyor(s) 20 convey the corn C in the first direction (arrow A). For example, the control system 200 can receive signals and/or data from one or more encoders (FIG. 6) of the conveyor 20 that correspond to movement of the conveyor 20 over a time period. The control system 200 may continuously receive signals and/or data from the encoder and update the current corn position to thereby track the position of the corn C as it is conveyed by the conveyor 20. In another example, a light curtain or laser system (not depicted) is used with (or as a substitute for) the encoder to generate the position data corresponding to the corn C. In one of these examples, as the leading end of the corn C enters a light plane generated by the light curtain system that is at a known location, the light curtain system generates and sends signals to the control system 200. Once the opposite trailing end of the corn C passes the light curtain system ceases generating the signals and the control system 200 processes the data to determine the location of the corn C including the ends. The control system 200 also utilizes other data (e.g., speed of the conveyor 20, time of conveyance), such that the real time position of the corn C can be determined.

The present inventors observed that conventional food processing systems for processing corn often include conventional alignment machines for properly reorienting in the proper direction for processing by conventional cutter machines. The conventional cutter machines are configured to cut the kernels from the cob, and these conventional cutter machines require that the corn enter the machine tip end first. The conventional cutter machines are not able to process corn quickly (e.g., conventional cutter machines are slow and cannot easily increase output) and are not reliable for accurately reorienting different types, varieties, shapes, and/or sizes of corn. If the tail end of the corn enters the conventional cutter machines first, the machine may jam resulting in machine downtime. To avoid these problems at the conventional cutter machines, the conventional food processing systems include conventional alignment machines that reorienting any corn from a tail-end first orientation to a tip-end first orientation. Some conventional alignment machines flip the misaligned corn into the correct orientation. An example conventional alignment machine is commercially available from Magnuson CCM (model ACC) However, flipping the corn may damage the kernels and/or the corn may be inadvertently ejected from the conventional alignment machines resulting in jams, trip hazards, damage to other components of the systems, and/or debris. As such, the present inventors endeavored to develop the example food processing system 10 of the present disclosure that includes an alignment section for properly aligning any misaligned corn C without damaging the corn C, more reliably and consistently reorientate the corn C, reduce system downtime, reduce manual labor, and/or solving other problems or drawbacks of conventional alignment machines and/or conventional food processing systems.

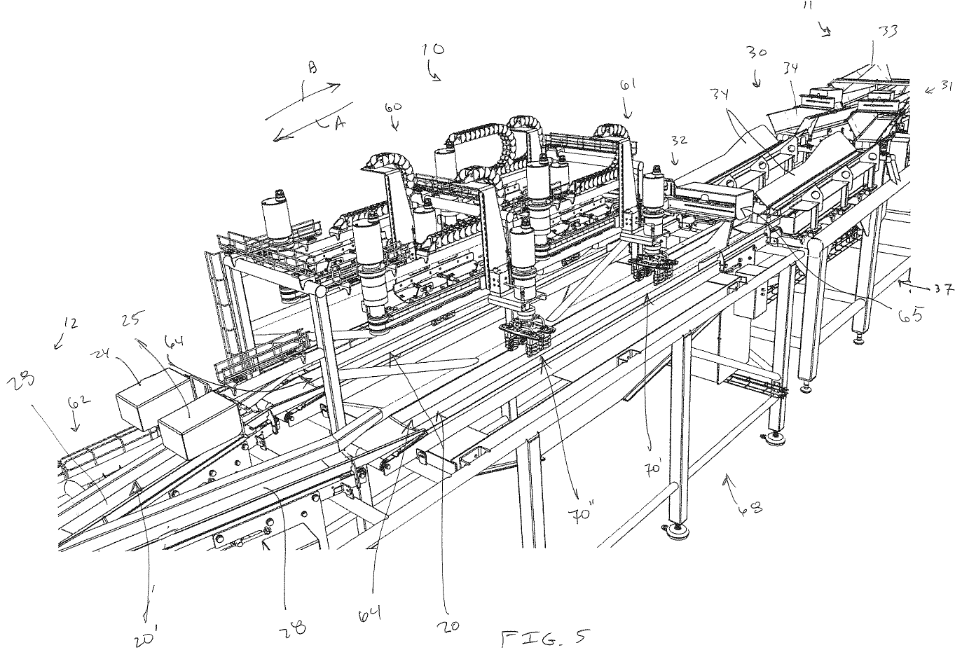

Referring to FIGS. 4-5, the alignment section 60 includes a frame 68 that supports the conveyors 20 and the sensing system 65. The frame 68 extends from the ground G and vertically above the conveyors 20. One or more sorting devices, for example manipulator or a robot 70′, 70″ with an operable arm 71, are coupled to the frame 68 and positioned above the conveyors 20. The robots 70 are coupled to a track 69 and are movable along the track 69 (described further herein). Note that the track extends parallel to the conveyors 20.

Each robot 70′, 70″ is for selectively engaging the corn C on the conveyor 20 as the conveyors 20 convey the corn C in the first direction (arrow A). The robot 70′, 70″ includes one or more actuators (not depicted; e.g., linear actuator or pneumatic piston cylinder) for moving the robot 70 along the track 69 and for moving components of the robot 70′, 70″ such as the arm 71 (described further herein). The robot 70′, 70″ includes a gripper, e.g. suction cup or gripping fingers 72, for engaging and handling the corn C. The robot 70′, 70″ can include other components such as pneumatic piston cylinders, motors, linear actuators, servo motors, motors, and/or solenoids.

The robot 70′, 70″ is in communication with the control system 200, and the control system 200 sends control signals to the robot 70′, 70″ based on input the control system 200 receives from the sensing system 65 and/or conveyors 20 such as encoders.

Generally, as will be described in greater detail, the sensing system 65 senses each corn C passing the sensing system 65. The sensor 66 relays signals and/or data relating to the orientation of the corn C (e.g., image of the corn C, amount or width of the light curtain emitted by the sensor 66 that is broken by end of the corn C oriented in the first direction) to the control system 200. In certain examples, the sensing system 65 includes a two dimensional (2D) profile scanner or a three dimensional (3D) profile scanner. The type of scanner can vary and be configured to utilize LiDAR, utilize photo eyes, generate point clouds, utilize laser, and/or the like. In certain examples, the sensing system 65 includes sensor 66 that emits a sensing beam or laser to generate signals and/or data corresponding to a 2D or 3D image as the corn C as the corn passes through the sensing beam. The sensor 66 is capable of sensing the entire width of the conveyor 20 (see for example FIG. 4 which depicts the range of the sensor 66 across the conveyor if dashed lines). The sensor 66 is configured to rapidly scan and sample the height of the corn C relative to the belt of the conveyor 20 and thereby can generate signals and/or data corresponding to a 3D image of the corn C.

In certain examples, the control system 200 incorporates machine learning such that the control system 200 can determine the difference between the tip end of the corn C and the tail end of the corn C cob. In some instances, the control system 200 can ‘learn’ the difference between the tip end of the corn C and the tail end of the corn C cob based on analyzing training images and receiving training input from the operator. For instance, the training images could include a set of tip end leading examples and a set of tail end leading examples that are scanned by the control system 200 and the verified to be correct by the operator the food processing system 10. In this way the control system 200 can learn to determine the tip end of the corn C and the tail end of the corn C cob

In certain examples, the control system 200 can determine the location of the center of gravity of the corn C based on the 3D image of the corn C and algorithm or look-up tables related to the weight and/or center of gravity and the 3D image of the corn C.

The control system 200 determines if the corn C is properly oriented (e.g., tip end of the corn C is oriented in the first direction). Note that in other examples, the sensing system 65 determines if the corn C is properly oriented and sends corresponding signals to the control system 200. If the corn C is properly oriented, the corn C is simply conveyed by the conveyor 20 to the cutter section 90. However, if the corn C is not properly oriented (e.g., the tail end of the corn C is oriented in the first direction), the control system 200 sends control signal(s) to the robot(s) 70′, 70″ to track, follow, engage, and/or reorient the corn C such that the corn C is properly oriented (e.g., the tip end of the corn C is oriented in the first direction). The control system 200 can identify the tail end 51 or the tip end 52 of the corn C and/or determine if the tail end 51 or the tip end 52 is oriented toward the second alignment end 32.

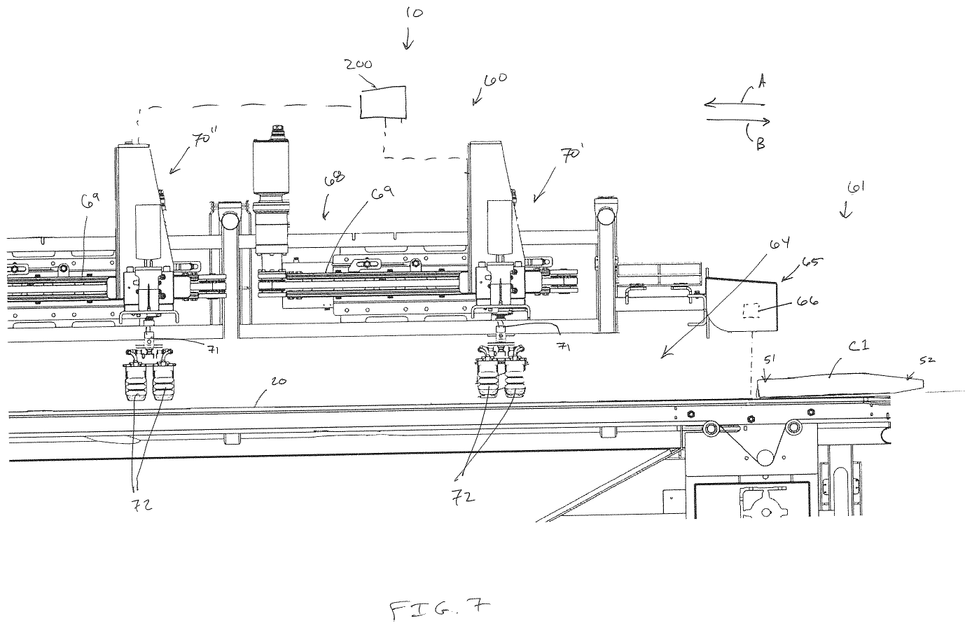

FIGS. 7-10 depict an example operational sequence for sensing and/or reorienting corn C so that all the corn C is properly oriented for cutting in the cutter section 90.

In FIG. 7, a first corn C1 is received into the alignment section 60 via the first alignment end 61 from the input section 30 (FIG. 1). The first corn C1 is received onto the conveyor 20 which conveys the first corn C1 along the path 64 through the alignment section 60 in the first direction (arrow A) toward the second alignment end 62 (FIG. 5). Note that the first corn C1 (and the other corn described in this example operational sequence) is schematically depicted with a tail end 51 and a tip end 52.

The alignment section 60 includes a first sorting device, e.g., a first robot 70′, and a second sorting device, e.g., a second robot 70″. The second robot 70″ is located downstream from the first robot 70′. Both the robots 70′, 70″ are in first positions, respectively.

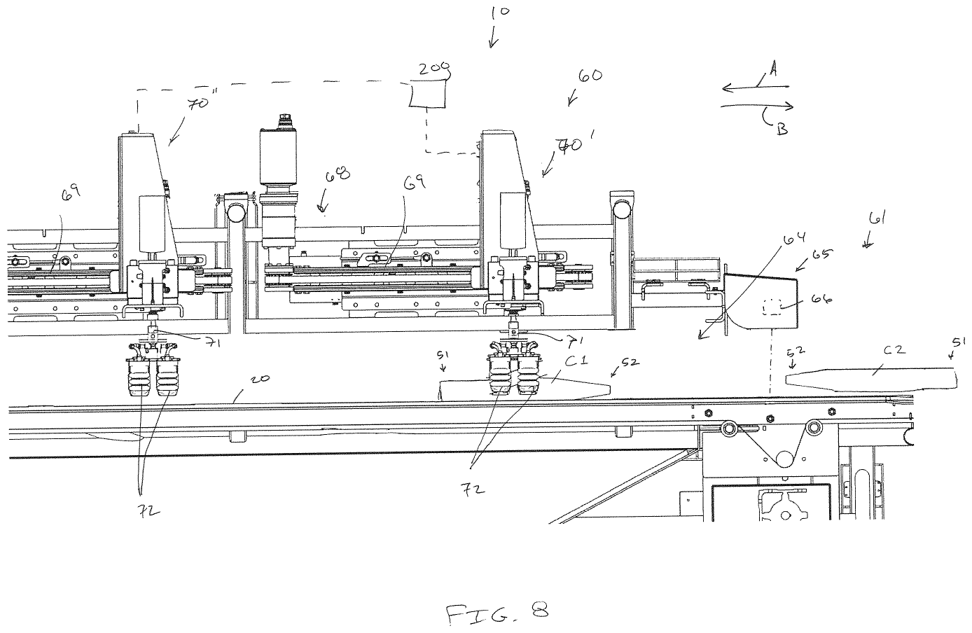

As the first corn C1 is conveyed from the location depicted in FIG. 7 to the location depicted in FIG. 8, the sensing system 65 sense the first corn C1 and sends signals and/or data to the control system 200. In one example, the sensor 66 of the sensing system 65 is a laser curtain and the sensor 66 outputs signals and/or data related to the width of the laser curtain is broken when the first corn C1 passes the laser (depicted as a dash-dot line). When the tail end 51 is oriented in the first direction the width of the laser curtain is large when compared to when the tip end 52 of the first corn C1 is oriented in the first direction. Based on the signals and/or data received by the control system 200, the control system 200 determines if the tip end 52 is oriented in the first direction (arrow A) or in an opposite second direction (arrow B) toward the first alignment end 61. In the example, depicted in FIGS. 7-8, the control system 200 determines based on signals and/or data from the sensor 66 that the tip end 52 is oriented in the second direction and further determines the location of the first corn C1 on the conveyor 20.

FIG. 8 depicts the first corn C1 conveyed by the conveyor 20 to the first robot 70′. The first robot 70′ has a plurality of fingers 72. The control system 200 tracks the location of the first corn C1, and when the first corn C1 is located between opposing sets of the fingers 72, the control system 200 sends control signals to the first robot 70′ (e.g., actuators of the first robot 70′) to cause the fingers 72 to grip and engage the first corn C1. Note that in other examples, the first position of the first robot 70′ may include the fingers 72 being located vertically above the position of the fingers 72 depicted in FIG. 8 such that the control system 200 may cause the arm 71 and the fingers 72 to be moved vertically toward the first corn C1 before gripping the first corn C1.

A second corn C2 is also received onto the conveyor 20 which conveys the second corn C2 along the path 64 through the alignment section 60 in the first direction (arrow A). Note that the second corn C2 is oriented with the tip end 52 in the first direction.

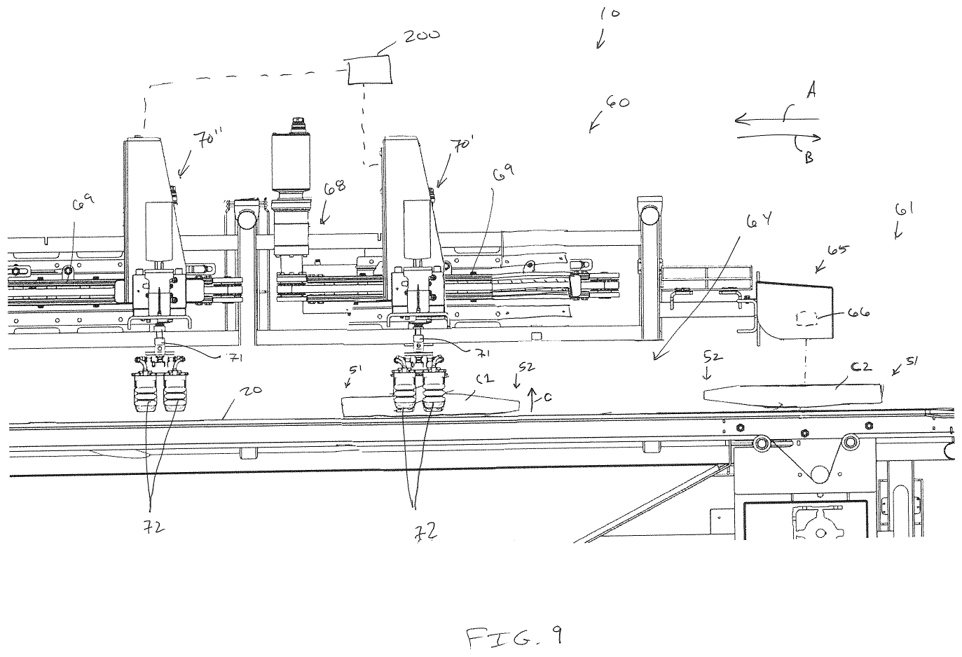

FIG. 9 depicts the first robot 70′ and the first corn C1 moved downstream in the first direction (arrow A). The first robot 70′ is in a second position. As the first robot 70′ moves in the first direction (arrow A) from the first position (FIG. 8) to the second position (FIG. 9) the first robot 70′ holds and carries the first corn C1 in the first direction (arrow A). In addition, the first robot 70′ vertically moves the first corn C1 away from and lifts the first corn C1 off the conveyor 20 (see arrow C).

As the second corn C2 is conveyed from the location depicted in FIG. 8 to the location depicted in FIG. 9, the sensing system 65 sense the second corn C2 and sends signals and/or data to the control system 200. In this example, the tip end 52 is oriented in the first direction and determines the location of the second corn C2 on the conveyor 20.

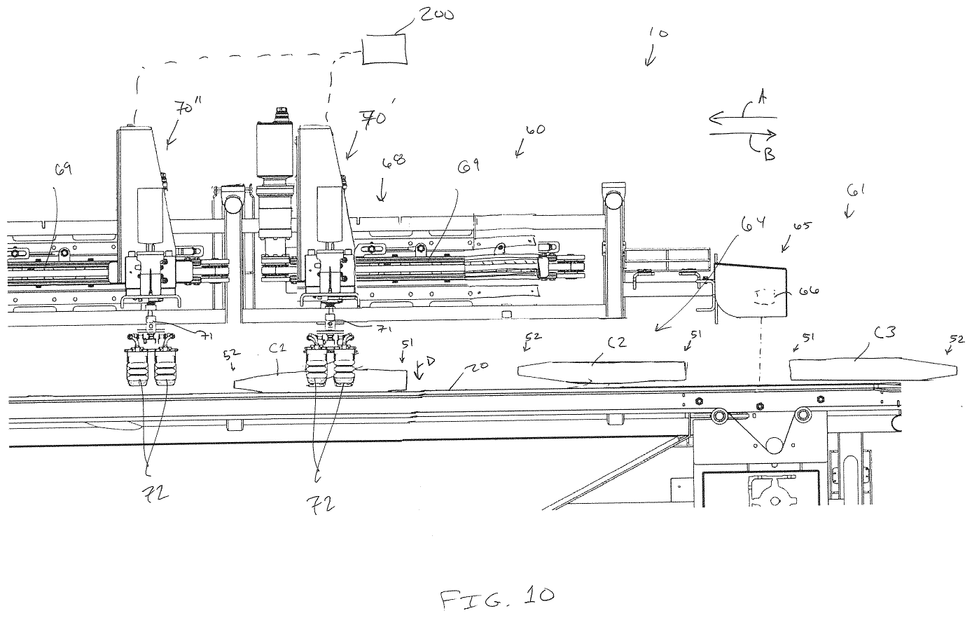

FIG. 10 depicts the first robot 70′ and the first corn C1 moved further downstream in the first direction (arrow A). The first robot 70′ is in a third position. As the first robot 70′ moves in the first direction (arrow A) from the second position (FIG. 9) to the third position (FIG. 10) the first robot 70′ holds and carries the first corn C1 in the first direction (arrow A) and additionally rotates the first corn C1 (e.g., 180.0 degrees, 178.0 degrees) such that the tip end 52 is oriented toward the second alignment end 62 and in the first direction. Subsequently, the fingers 72 of the first robot 70′ release the first corn C1 such that the first corn C1 falls onto the and is once again conveyed in the first direction by the conveyor and/or the fingers 72 of the first robot 70′ are moved toward the conveyor (see arrow D). Accordingly, the first corn C1 can be conveyed by the conveyor 20 toward the cutter section 90 (FIG. 1).

Note that when the first robot 70′ releases the first corn C1 back onto the conveyor 20, the first corn C1 is in the same portion of the conveyor 20 as when the first corn C1 was engaged by the first robot 70′. In certain examples, the first robot 70′ moves in the first direction at the same speed as the conveyor 20. In other examples, the speed of the robot 70′ may slow and/or accelerate as the first robot 70′ is moved through the positions noted above while still placing the first corn C1 back onto the same portion of the conveyor 20.

The second corn C2 is further conveyed from the location depicted in FIG. 9 to the location depicted in FIG. 10.

A third corn C3 is also received onto the conveyor 20 which conveys the third corn C1 along the path 64 through the alignment section 60 in the first direction (arrow A). Note that the third corn C3 is oriented with the tip end 52 in the second direction.

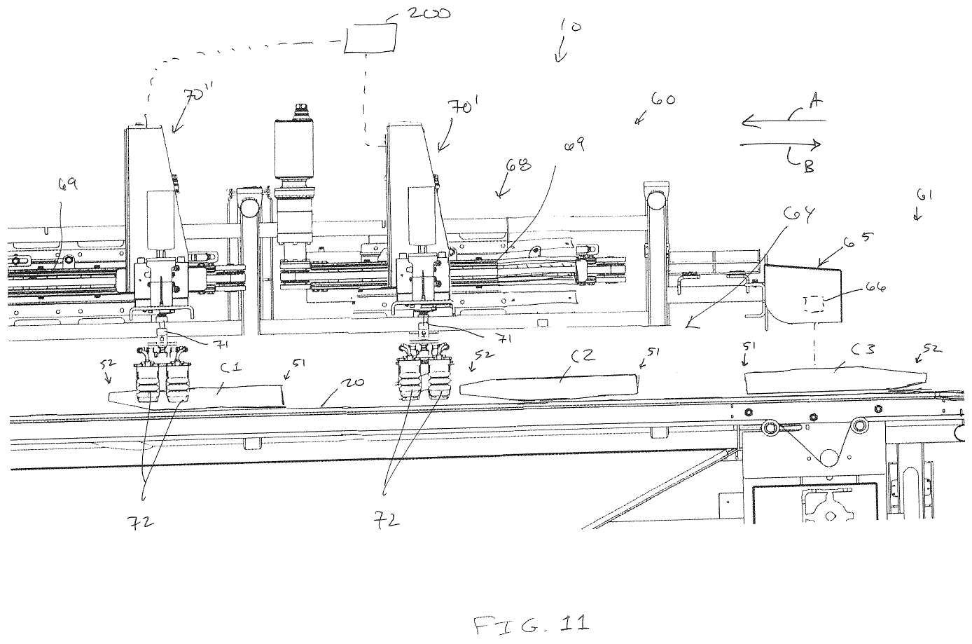

In FIG. 11, the first corn C1 is conveyed further downstream in the first direction (arrow A) by the conveyor 20. The first corn C1 passes through the fingers 72 of the second robot 70″. The conveyor 20 conveys the first corn C1 in the proper orientation to the cutter section 90.

The first robot 70′ is depicted as moved back in the second direction (arrow B) back toward the first position (FIG. 7). The control system 200 based on the signals and/or data from the sensing system 65 determined that the second corn C2 is in the proper orientation with the tip end 52 oriented toward the second alignment end 62 and in the first direction. As such, the control system 200 does not cause the first robot 70′ to engage the second corn C2. Instead, the control system 200 causes the first robot 70′ to move to an idle position, such as the first position (FIG. 7) until another corn on the conveyor 20 must be reoriented.

The third corn C3 is sensed by the sensing system 65 and the control system 200 determines that the tip end 52 is oriented in the second direction and further determines the location of the third corn C3. Once the third corn C3 is conveyed by the conveyor 20 to the first robot 70′ (whether the first robot 70′ is in the idle position or the first position or moving toward the idle position or the first position), the first robot 70′ will engage and reorient the third corn C3 as described above with respect to the first corn C1.

It is possible that the several consecutive corn cobs received into the alignment section 60 may be improperly oriented. As such, the second robot 70″ can be utilized by the control system 200 to assist the first robot 70′ in correctly orientating the corn. The use of the second robot 70″ may be necessary to properly reorientate all the improperly orientated corn due to the limits on the movement speeds of the first robot 70′, the speed of the conveyor 20, the spacing between each corn on the conveyor 20, and/or other factors. In one instance, the control system 200 may determines that three consecutive corns on the conveyor 20 are improperly orientated and thereby control the first robot 70′ to reorientate the first one of the corns. After the first robot 70′ reorientates the first one of the corn and is moving back toward the first position, the second one of the corns passes under and/or through the first robot 70′ to the second robot 70″ which is waiting for the second one of the corn. The second robot 70″ reorientates the second one of the corns in an operation similar to the operation described above with respect to the first robot 70′. The first robot 70′ then reorientates the third one of the corns as described above. The control system 200 continuously monitors the corn on the conveyor 20 via the sensing system 65 and further controls the robots 70′, 70″ accordingly. Note that the number of robots 70 can vary, and in other examples the alignment section 60 could include three or four robots 70 for reorienting the corn.

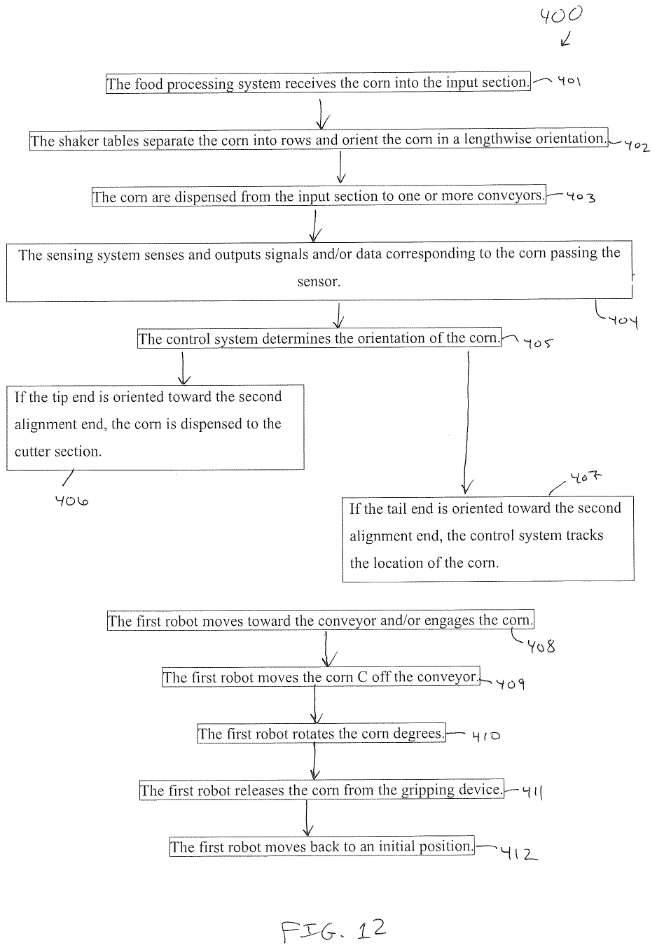

FIG. 12 depicts an example method 400 for operating the food processing system according to the present disclosure which is described herein below. Note that the example method 400 can include other features, concepts, and/or sequence steps described in the present application of the example food processing systems 10 noted above. Also, note that one or more steps of the example method 400 can be modified or excluded such that other example methods accordingly the present disclosure are possible.

The method 400 begins at step 401 with the food processing system 10 receiving a plurality of corn C into the input section 30 for a source, such as a hopper that stores a large quantity of corn C therein and dispenses the corn C to the input section 30 at a desired flow rate or based on control signals received from the control system 200.

Before and/or during receiving the corn, the shaker tables 33 and the input section conveyors 34 are operated and thereby cause corn C to moved in the downstream direction (arrow A) and separated into rows of corn C that are oriented in a lengthwise orientation in one or more single file lines or rows of corn C that are oriented relative to each other end-to-end, at step 402. In certain examples, additional sensors 35 (see FIG. 3; e.g., photo eyes) are located along the input section 30 and are for sensing the corn C and/or space/gap between the corn C. In one instance, if the additional sensor 35 does not sense a space between adjacent corn C the control system 200 determines that the adjacent corns C are too close or overlap each other and thereby change the speed (e.g., increases or decreases) the input section conveyors 34 so that the adjacent corn C are properly spaced apart from each other. In one example, the sensors 35 generate signals when the presence of the corn C is sensed. The control system 200 determines a sensed length of time the signal is received from the sensor 35 (e.g., 0.5 seconds) using a timer. If the sensed length of time is greater than a predetermined length of time (e.g., the predetermined length of time is a time or time range an corn C with average length passes by the sensor 35; 0.25 seconds), the control system 200 determines that the corn C are overlapping and/or no space between the corn C. As such, the control system 200 changes the speed of the input section conveyors 34 and/or the conveyors 20 to create a space or gap between the adjacent corn C.

At step 403 the corn C is dispensed from the input section 30 to one or more conveyors 20 that convey the corn C through the alignment section 60 in the first direction (arrow A).

The sensing system 65, at step 404, senses and outputs signals and/or data corresponding to the corn C passing the sensor 66.

The control system, at step 405, receives the signals and/or data from the sensor 66 and processing the signals and/or data to determine the orientation of the corn.

If the control system 200 determines that the tip end 52 is oriented in the first direction (arrow A) and toward the second alignment end 62, the corn C is in the correct or proper orientation for processing in the cutter section 90. As such, at step 406, the conveyor 20 tracks the location of the corn C and conveys the corn C to the second alignment end 62 and the corn C is dispensed to the cutter section 90 for further processing.

However, if the control system 200 determines that the tail end 51 is oriented in the first direction (arrow A) and toward the second alignment end 62, the corn C is not in correct or proper orientation for processing in the cutter section 90. As such, the step 407, in the control system 200 determines and tracks the location of the corn C on the conveyor 20. The control system 200 provides control signals to components of the food processing system 10 to facilitate additional steps of the method 400 described herein.

At step 408, the first robot 70′ optionally causes the fingers 72 to move a direction toward the conveyor 20 and/or the fingers 72 engage the corn C.

At step 409, the first robot 70′ moves the gripping device(s), e.g. fingers 72, and the corn C in a direction away from the conveyor 20 thereby lifting the corn C off the conveyor 20.

At step 410, the first robot 70′ rotates the corn C so that the tip end 52 is oriented in the first direction and determines the location of the second corn C2 on the conveyor 20.

The first robot 70′, at step 411, the first robot 70′ releases the corn C from the fingers 72 back onto the conveyor 20.

Note that the first robot 70′ can move along the track in the first direction (arrow A) and/or the second direction (arrow B) while and/or in between the steps 408 to 411 described above such that the first robot 70′ places the corn C back on the conveyor 20 in the same location on the conveyor 20 that the first robot 70′ first engaged the corn C.

At step 412 the first robot 70′ moves back to an initial or first position where the first robot 70′ waits for further control signals from the control system 200 to reorientate additional improperly orientated corn C by utilizing similar steps as noted above for the method 400.

In certain examples, the method 400 also includes the steps of sensing with the sensing system 65 additional corn C received into the alignment section 60. The control system 200 can reorientate the corn C as needed as described above with respect to the first robot 70′. Optionally, the control system 200 may allow the corn C that needs to be reoriented to pass by the first robot 70′ to a second robot 70″ that may process the corn C in a similar manner that is described above with respect to the first robot 70′. As such, the use of the second robot 70″ advantageously allows alignment section 60 to process the corn C faster thereby increasing the output of correctly orientated corn C through the alignment section 60 to the cutter section 90.

In certain examples, the method 400 also includes the steps of funneling the corn C processed in more than one path 64 on more than one conveyors 20 to another conveyor 20″ (referred to herein as an output conveyor 20″) that dispenses the corn C to the cutter section 90. Each of the two conveyors 20 that convey the corn C along two paths 64 and one or more robots 70′, 70″ can include a converging conveyor section 20′ that converge toward the output conveyor 20″. As the corn C is processed and optionally reoriented as described above, the corn C is directed toward the output conveyor 20″. To avoid the corn C on each of the converging conveyor section 20′ from contacting each other when dispensed to the output conveyor 20″ the control system 200 is configured to speed up or slow down the converging conveyor sections 20′ to prevent the corn C from either path 64 from contacting each other on the output conveyor 20″ and thereby avoid jamming the corn C. As noted above, the control system 200 tracks the location on the corn C on the conveyor 20 and if the control system 200 determines that the corn C may conflict or contact each other when dispensed from the converging conveyor sections 20′ to the output conveyor 20″ the control system 200 will adjust the speed one or more of the converging conveyor sections 20′ to avoid the conflict of the corn C on the output conveyor 20″. In certain examples, the control system 200 takes signals from a first sensor 24 and a second sensor 25 (e.g., photo eyes) that are each located at different legs with separate converging belts 28 of the converging conveyor section 20′ (e.g., above the converging conveyor section 20′). The sensors 24, 25 are configured to sense the presence of corn C passing along the legs of the converging conveyor sections. If sensor 24, 25 sense corn C at the same time and/or the same longitudinal position (e.g., the sensors 24, 25 are aligned with each other and sense a location of the converging conveyor section 20′ are in the same longitudinal position between the ends 11, 12 of the system 10), the control system 200 controls the speed of the one or both belts of the converging conveyor section 20′ so that corn C dispensed to the output conveyor 20″ do not interfere with each other (e.g., the corn on the converging conveyor sections 20′ are dispensed end-to-end).

In certain examples, a method for processing a food product includes conveying, with a conveyor, the food product in a first direction, sensing, with a sensing system, the food product, determining, with a control system, orientation of the food product, engaging, with a robot, the food product, moving the robot in the first direction such that the robot moves the food product in the first direction, reorienting, with the robot, the food product, placing, with the robot, the food product onto the conveyor, and moving the robot in a second direction opposite the first direction.

In certain examples, a method for processing a food product includes conveying, with a conveyor, the food product in a first direction, sensing, with a sensing system, the food product, determining, with a control system, orientation of the food product, engaging, with a robot, the food product, reorienting, with the robot, the food product, placing, with the robot, the food product onto the conveyor, and moving the robot in a second direction opposite the first direction.

In certain examples, a method for processing a food product includes conveying, with a conveyor, the food product in a first direction, sensing, with a sensing system, the food product, determining, with a control system, orientation of the food product, engaging, with a robot, the food product, reorienting, with the robot, the food product, and placing, with the robot, the food product onto the conveyor.

Optionally including lifting, with the robot, the food product off the conveyor and the placing the food product onto the conveyor includes placing the food product onto the conveyor in the same location on the conveyor in which the food product was lifted off the conveyor. Optionally, the food product is a corn and the method is for orientating a tip end of the corn in the first direction. Optionally, the determining orientation of the food product includes identifying the tip end of the corn. Optionally, the robot is a first robot and the food product is first food product and conveying a second food product, with the conveyor, in the first direction past the first robot. Optionally including sensing, with a sensing system, the second food product, determining, with the control system, orientation of the second food product, engaging, with a second robot, the second food product, reorienting, with the second robot, the second food product, and placing, with the second robot, the second food product onto the conveyor. Optionally including sensing, with a sensing system, the second food product, determining, with the control system, orientation of the second food product, engaging, with a second robot, the second food product, reorienting, with the second robot, the second food product, placing, with the second robot, the second food product onto the conveyor, and moving the second robot in the second direction opposite the first direction. Optionally, the conveyor is a first conveyor and including conveying an additional food product, with a second conveyor, in the first direction, dispensing the food product from the first conveyor to an output conveyor, dispensing the additional food product from the second conveyor the output conveyor, and controlling, the control system, speed of the first conveyor and/or the second conveyor to space the additional food product apart from the food product on the output conveyor. Optionally including dispensing the food product and the additional food product from the output conveyor to a cutter section, the food product is a first corn and the additional food product is a second corn and the cutter section is configured to cut kernels from a cob of the first corn and the second corn. Optionally including dispensing the food product to a cutter section, the food product is a first corn, and the cutter section is configured to cut kernels from a cob of the first corn.

In certain examples, a food processing system for processing a food product includes a conveyor configured to convey the food product in a first direction, a sensing system configured to sense the food product on the conveyor and output corresponding signals, a control system that receives the signals from the sensing system and determine orientation of the food product on the conveyor, and a robot configured to engage the food product, move the food product in the first direction, reorientate the food product, and release the food product onto the conveyor when the control system determines that the food product is improperly orientated.

In certain examples, a food processing system for processing a food product includes a conveyor configured to convey the food product in a first direction, a sensing system configured to sense the food product on the conveyor and output corresponding signals, a control system that receives the signals from the sensing system and determine orientation of the food product on the conveyor, and a robot configured to engage the food product, move the food product in the first direction, reorientate the food product, and release the food product onto the conveyor when the control system determines that the food product is improperly orientated.

Optionally, the robot is configured to lift the food product in a direction away from the conveyor before reorienting the food product. Optionally, the robot is configured to move the food product in a direction toward the conveyor after reorienting the food product. Optionally, the robot is configured to release the food product onto the conveyor in the same location on the conveyor in which the food product was engaged by the conveyor. Optionally, the food product is a corn. Optionally, the control system determines if a tip end or a tail end of the corn is oriented in the first direction. Optionally, the robot is a first robot and the sensing system is configured to sense an additional food product on the conveyor and output corresponding signals, the control system determines orientation of the additional food product on the conveyor, and including a second robot configured to engage the additional food product, move the additional food product in the first direction, reorientate the additional food product, and release the additional food product onto the conveyor when the control system determines that the additional food product is improperly orientated. Optionally, the robot is a first robot and the sensing system is configured to sense an additional food product on the conveyor and output corresponding signals, the control system determines orientation of the additional food product on the conveyor, and including a second robot configured to engage the additional food product, reorientate the additional food product, and release the additional food product onto the conveyor when the control system determines that the additional food product is improperly orientated. Optionally, the conveyor is configured to convey the additional food product past the first robot to the second robot. Optionally, the food product is a first food product and the conveyor is a first conveyor and a second conveyor configured to convey a second food product in the first direction, an output conveyor configured to receive the first food product from the first conveyor and the second food product from the second conveyor, and the control system controls speed of the first conveyor and/or the second conveyor to space the second food product from the first food product. Optionally, a converging conveyor section is configured to receive the first food product from the first conveyor and the second food product from the second conveyor, convey and converge the first food product and the second food product along a two separate converging belts toward the output conveyor, and dispense the first food product and the second food product to the output conveyor, and a first sensor configured to sense presence the first food product and a second sensor configured to sense presence the second food product, the first sensor is configured to generate a signal when the first food product is sensed and the second sensor is configured to generate a signal when the second food product is sensed, the control system receives signals from the first sensor and the second sensor, wherein if signals from the second sensor and signals from the first sensor are received at the same time the control system changes the speed of one or both of the belts such that the first food product does not interfere with the second food product as the first food product and the second food product dispense to the output conveyor. Optionally, the food product is a first food product and including an input section configured to receive the first food product and a second food product and dispense the first food product and the second food product to the conveyor, a sensor configured to sense presence of the first food product and the second food product and generate corresponding signals, and the control system receives signals from the sensor, if signals from the sensor are received for a time period greater than a predetermined time, the control system determines that the first food product and the second food product are overlapped and thus controls speed of the conveyor to space the first food product from the second food product.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for processing a food product, the method including:
conveying, with a conveyor, the food product in a first direction;
sensing, with a sensing system, the food product;
determining, with a control system, orientation of the food product;
engaging, with a robot, the food product;
reorienting, with the robot, the food product; and
placing, with the robot, the food product onto the conveyor.

2. The method according to claim 1, further comprising lifting, with the robot, the food product off the conveyor and wherein the placing the food product onto the conveyor includes placing the food product onto the conveyor in the same location on the conveyor in which the food product was lifted off the conveyor.

3. The method according to claim 1, wherein the food product is a corn and wherein the method is for orientating a tip end of the corn in the first direction.

4. The method according to claim 3, wherein the determining orientation of the food product includes identifying the tip end of the corn.

5. The method according to claim 1, wherein the robot is a first robot and the food product is first food product and further comprising conveying a second food product, with the conveyor, in the first direction past the first robot.

6. The method according to claim 5, further comprising:
sensing, with a sensing system, the second food product;
determining, with the control system, orientation of the second food product;
engaging, with a second robot, the second food product;
reorienting, with the second robot, the second food product; and
placing, with the second robot, the second food product onto the conveyor.

7. The method according to claim 1, wherein the conveyor is a first conveyor and further comprising:
conveying an additional food product, with a second conveyor, in the first direction;
dispensing the food product from the first conveyor to an output conveyor;
dispensing the additional food product from the second conveyor the output conveyor; and
controlling, the control system, speed of the first conveyor and/or the second conveyor to space the additional food product apart from the food product on the output conveyor.

8. The method according to claim 7, further comprising:
dispensing the food product and the additional food product from the output conveyor to a cutter section, wherein the food product is a first corn and the additional food product is a second corn, and wherein the cutter section is configured to cut kernels from a cob of the first corn and the second corn.

9. The method according to claim 1, further comprising:
dispensing the food product to a cutter section, wherein the food product is a first corn, and wherein the cutter section is configured to cut kernels from a cob of the first corn.

10. A food processing system for processing a food product, the food processing system comprising:
a conveyor configured to convey the food product in a first direction;
a sensing system configured to sense the food product on the conveyor and output corresponding signals;
a control system that receives the signals from the sensing system and determine orientation of the food product on the conveyor;
a robot configured to engage the food product, reorientate the food product, and release the food product onto the conveyor when the control system determines that the food product is improperly orientated.

11. The food processing system according to claim 10, wherein the robot is configured to lift the food product in a direction away from the conveyor before reorienting the food product.

12. The food processing system according to claim 11, wherein the robot is configured to move the food product in a direction toward the conveyor after reorienting the food product.

13. The food processing system according to claim 10, wherein the robot is configured to release the food product onto the conveyor in the same location on the conveyor in which the food product was engaged by the conveyor.

14. The food processing system according to claim 10, wherein the food product is a corn.

15. The food processing system according to claim 14, wherein the control system determines if a tip end or a tail end of the corn is oriented in the first direction.

16. The food processing system according to claim 14, wherein the robot is a first robot; and
wherein the sensing system is configured to sense an additional food product on the conveyor and output corresponding signals, the control system determines orientation of the additional food product on the conveyor; and further comprising a second robot configured to engage the additional food product, move the additional food product in the first direction, reorientate the additional food product, and release the additional food product onto the conveyor when the control system determines that the additional food product is improperly orientated.

17. The food processing system according to claim 16, wherein the conveyor is configured to convey the additional food product past the first robot to the second robot.

18. The food processing system according to claim 10, wherein the food product is a first food product and the conveyor is a first conveyor, and further comprising:
a second conveyor configured to convey a second food product in the first direction;
an output conveyor configured to receive the first food product from the first conveyor and the second food product from the second conveyor; and
wherein the control system controls speed of the first conveyor and/or the second conveyor to space the second food product from the first food product.

19. The food processing system according to claim 18, further comprising:
a converging conveyor section that is configured to receive the first food product from the first conveyor and the second food product from the second conveyor, convey and converge the first food product and the second food product along a two separate converging belts toward the output conveyor, and dispense the first food product and the second food product to the output conveyor; and
a first sensor configured to sense presence the first food product and a second sensor configured to sense presence the second food product, wherein the first sensor is configured to generate a signal when the first food product is sensed and the second sensor is configured to generate a signal when the second food product is sensed;
wherein the control system receives signals from the first sensor and the second sensor, wherein if signals from the second sensor and signals from the first sensor are received at the same time the control system changes the speed of one or both of the belts such that the first food product does not interfere with the second food product as the first food product and the second food product dispense to the output conveyor.

20. The food processing system according to claim 10, wherein the food product is a first food product, and further comprising:
an input section configured to receive the first food product and a second food product and dispense the first food product and the second food product to the conveyor;
a sensor configured to sense presence of the first food product and the second food product and generate corresponding signals;
wherein the control system receives signals from the sensor, wherein if signals from the sensor are received for a time period greater than a predetermined time, the control system determines that the first food product and the second food product are overlapped and thus controls speed of the conveyor to space the first food product from the second food product.
